(19) United States
(12) Patent Application Publication
(10) Pub. No.: US 2010/0261633 A1
(43) Pub. Date: Oct. 14, 2010

(54) DETERGENT BUILDER GRANULE

(76) Inventors: Kazuo Oki, Wakayama (JP); Toshima Kume, Wakayama (JP); Motomitsu Hasumi, Wakayama (JP); Tadanobu Asada, Wakayama (JP); Yuya Kozaki, Wakayama (JP); Jun Kozuka, Wakayama (JP)

Correspondence Address: BIRCH STEWART KOLASCH & BIRCH, PO BOX 747, FALLS CHURCH, VA, 22040-0747, US

(21) Appl. No.: 12/742,414

(22) PCT Filed: Oct. 20, 2008
(86) PCT No.: PCT/JP2008/068970

§ 371 Date: May 11, 2010

(30) Foreign Application Priority Data
Nov. 16, 2007 (JP) 2007-298521
Apr. 15, 2008 (JP) 2008-105897

(51) Int. Cl. C11D 7/14

(52) U.S. Cl. 510/276; 510/532

(57) ABSTRACT

Detergent builder granules containing (component A) a water-soluble inorganic salt containing an inorganic salt having and/or being capable of forming a hydrate crystal and (component B) a clay mineral, wherein the component B is contained in an amount of 60% by weight or less, the component A and the component B are in a weight ratio, i.e. A/B, calculated as an anhydrate, of from 5/95 to 80/20, and a percentage of water loss upon heating to a temperature of 200° C. is from 3 to 30% by weight. According to the present invention, the detergent builder granules for laundry detergents having excellent dispersibility in cold water and a detergent composition containing the detergent builder granules can be obtained.

### TECHNICAL FIELD

The present invention relates to detergent builder granules having excellent dissolubility at low temperatures, and a detergent composition containing the detergent granules.

### BACKGROUND ART

Conventionally, in order to intensify the washing power of detergents, builder granules of sodium carbonate or sodium sulfate are blended with the detergent granules (Patent Publication 1). These granules of a water-soluble inorganic salt may form a hydrate crystal upon contact with water in some cases, and especially when contacted with a cold water of 5° C. or lower, the granules are melted and fused to be formed into a paste, and thereafter a firm network of hydrate crystals is formed, so that the granules are less likely to be dispersed in water. Such phenomena may cause some troubles of leaving some detergents on clothes in laundering in households in the wintry season in certain cases. Therefore, it is tried to improve dispersibility at low temperatures by a treatment such as previous formation of a hydrate as described in Patent Publications 2 and 3; however, an effect of improving dispersibility is yet insufficient. In addition, as in Patent Publication 4, a technique of preventing the aggregation of the inorganic salts themselves by adding a water-insoluble builder (zeolite) is also tried. Conversely, as in Patent Publication 5, there is also a technique of using a bentonite aggregate. In any case, further improvements are desired.

### Patent Publication 1: JP-A-Showa-64-10040

### Patent Publication 2: JP-A-2003-193091

### Patent Publication 3: JP-A-2004-238529

### Patent Publication 4: JP-A-2005-47790

### Patent Publication 5: JP-A-Showa-61-213298

### DISCLOSURE OF INVENTION

### Problems to be Solved by the Invention

An object of the present invention is to provide detergent builder granules for laundry detergents, having excellent dispersibility in cold water, and a detergent composition containing the detergent builder granules.

### Means to Solve the Problems

Specifically, the gist of the present invention relates to:
[1] detergent builder granules containing:
   (component A) a water-soluble inorganic salt containing an inorganic salt having and/or being capable of forming a hydrate crystal and
   (component B) a clay mineral,
   wherein the component B is contained in an amount of 60% by weight or less, the component A and the component B are in a weight ratio, i.e. A/B, calculated as an anhydrate, of from 5/95 to 80/20, and a percentage of water loss upon heating to a temperature of 200° C. is from 3 to 30% by weight; and
[2] a detergent composition containing the detergent builder granules as defined in [1].

### EFFECTS OF THE INVENTION

According to the present invention, detergent builder granules for laundry detergents, having excellent dispersibility in cold water, and a detergent composition containing the detergent builder granules are provided.

### BEST MODE FOR CARRYING OUT THE INVENTION

The detergent builder granules of the present invention contain:

(component A) a water-soluble inorganic salt containing an inorganic salt having and/or being capable of forming a hydrate crystal and
(component B) a clay mineral.

The term “water-soluble” in the water-soluble inorganic salt containing an inorganic salt having and/or being capable of forming a hydrate crystal (component A) in the present invention means inorganic salts listed in Kagaku-binran Kiso-hen I, Revised Third Edition (edited by The Chemical Society of Japan, published by Maruzen Publishing), of which solubility in water at 20° C. is 5 g/100 g or more. The component A includes water-soluble inorganic salts actually having hydrate crystals, and water-soluble inorganic salts capable of forming hydrate crystals when absorbing moisture or upon contacting water.

Those salts that are preferred as the component A are one or more salts selected from the group consisting of carbonates, sulfates, and chlorides. Among them, those that are especially preferred are carbonates and/or sulfates, which are generally used for detergent builders.

The carbonates are, for example, sodium carbonate, potassium carbonate, calcium carbonate, magnesium carbonate, ammonium carbonate, and hydrates thereof. Among them, sodium carbonate, sodium carbonate decahydrate, sodium carbonate heptahydrate, sodium carbonate monohydrate, sodium sesquicarbonate, and the like, that are generally used for detergent builders, are especially preferred. Also, it is more preferable that sodium carbonate and a hydrate thereof are both contained, from the viewpoint of providing excellent low-temperature dispersibility.

The sulfates are sodium sulfate, potassium sulfate, calcium sulfate, magnesium sulfate, and hydrates thereof. Among them, sodium sulfate and sodium sulfate decahydrate that are widely used as detergent builders are especially preferred. In addition, it is more preferable that both sodium sulfate and a hydrate thereof are contained, from the viewpoint of providing excellent low-temperature dispersibility.

The chlorides are sodium chloride, calcium chloride, magnesium chloride, and hydrates thereof. Among them, sodium chloride is preferred from the viewpoint of detergent performance.

The carbonates, the sulfates, and the chlorides in the detergent builder granules of the present invention may be individually used for a raw material in a single component, or in a mixture of two or more plural salts. Alternatively, the carbonate, the sulfate, and the chloride may be mixed and used for a raw material. In addition, in a case where a hydrate is contained in the detergent builder granules of the present invention, a hydrate may be used for the raw material, or an anhydride may be used for a raw material and reacted with water during the process of producing the granules to form a hydrate. In the granular formation (granulation) for the builder granules of the present invention, a technique including the step of using an anhydride as a raw material and allowing a part of the raw material to hydrate during the granulation process is preferred because the raw materials are not necessitated to be plurally formulated.

In addition, the component A may contain not only a water-soluble inorganic salt having a single anion such as a carbonate, a sulfate, or a chloride, but also a double salt of a carbonate and a sulfate (for example, burkeite), or the like.

The component A may contain an inorganic salt that is incapable of forming a hydrate crystal, and the inorganic salt that is incapable of forming a hydrate crystal includes potassium chloride, sodium nitrate, potassium nitrate, and the like.

The component A has an average particle size of preferably 1 μm or more, and more preferably 10 μm or more, from the viewpoint of providing excellent low-temperature dispersibility. In addition, the component A has an average particle size of preferably 1000 μm or less, more preferably 500 μm or less, and especially preferably 200 μm or less, from the viewpoint of providing excellent dissolubility of the granules.

The measurement of the average particle size of the components in the detergent builder granules of the present invention is carried out by a method including embedding detergent builder granules in a resin, observing a cross section of the detergent builder granules obtained by slicing the granules with ULTRAMICROTOME (manufactured by LEICA) with a SEM, and averaging diameters of cross sections (fillet diameter) of 30 granules. Here, the identification of the components of the individual granules is carried out by elemental analysis according to EDS.

The component A is contained in an amount of preferably 10% by weight or more, more preferably 20% by weight or more, and especially preferably 30% by weight or more, of the detergent builder granules, from the viewpoint of detergent performance. In addition, the component A is contained in an amount of preferably 80% by weight or less, more preferably 70% by weight or less, and especially preferably 60% by weight or less, of the detergent builder granules, from the viewpoint of providing excellent low-temperature dispersibility.

The inorganic salt having and/or being capable of forming a hydrate crystal in the component A of the detergent builder granules is contained in an amount of preferably 60% by weight or more, more preferably 70% by weight or more, and especially preferably 80% by weight or more, of the overall component A, from the viewpoint of detergent performance. In addition, the inorganic salt having and/or being capable of forming a hydrate crystal is contained in an amount of preferably 100% by weight or less, more preferably 95% by weight or less, and especially preferably 90% by weight or less, of the overall component A, from the viewpoint of low-temperature dispersibility.

The clay mineral (component B) includes talc, pyrophyllites, smectites such as saponite, hectorite, sauconite, stevensite, montmorillonite, beidellite and nontronite, vermiculites, micas such as phlogopite, biotite, zinnwaldite, muscovite, paragonite, celadonite and glauconite, chlorites such as clinochlore, chamosite, nimite, pennantite, sudoite and donbassite, brittle micas such as clintonite and margarite, thulite, serpentines such as antigorite, lizardite, chrysotile, amesite, cronstedtite, berthierine, greenalite and garnierite, kaolin minerals such as kaolinite, dickite, nacrite and halloysite, and the like. Among them, talc, smectites, swellable micas, vermiculites, chrysotile, the kaolin minerals and the like are preferable, from the viewpoint of improving the dispersibility of the detergent builder granules of the present invention in water. The smectites are more preferable, and the montmorillonite is even more preferable. As the montmorillonite, bentonite can be suitably used. These clay minerals can be used alone or in a combination of two or more kinds.

Specifically, the bentonite is represented by the following formula (I):

[MgₐAl_{b}(Si₂O₅)₄(OH)₄]^{X-}.Me^{X+} (I)

wherein a, b and x respectively satisfy 0<a≦6, 0<b≦4, and x=12−(2a+3b); Me^{X+} is a charge-balancing cation of at least one metal selected from Na, K, Li, Ca, Mg and NH₄, or ammonium, wherein Me^{X+} is introduced as a consequence of isomorphic ion replacement, and the degree isomorphic substitution determines the size of a layer charge, which is an important factor in the swelling of the bentonite, and the bentonite is a material wherein the clay mineral represented by the formula (I) is contained in an amount of preferably 90% by weight or more, more preferably 95% by weight or more, and especially preferably 98% by weight or more, of the overall clay mineral. The compound represented by the formula (I), for example, may be subjected to substitution of two Al³⁺ ions of the central octahedral layer with three Mg²⁺ ions, or to a partial substitution of one Mg²⁺ ion of the central octahedral layer with one Al³⁺ ion so that an excess negative charge may remain in the structure. The remaining of an excess negative charge can be generated in a case where Si⁴⁺ ion of the tetrahedral layer is substituted with Al³⁺ ion.

In addition, among the above-mentioned cations, the alkali metal ions, i.e. a total of Na ions, K ions, and Li ions, and alkaline earth metal ions, i.e. a total of Ca ions and Mg ions, are in a molar ratio, i.e. [(Na ions+K ions+Li ions)/(Ca ions+Mg ions)], of preferably 1.0 or more, more preferably 1.5 or more, and even more preferably 2.0 or more, from the viewpoint of dissolubility. In order to obtain a clay mineral having a high proportion of the alkali metal ions, if the clay mineral is a natural product, the producing region may be selected, and in a case where the clay granules are produced, an alkali metal salt can be added to prepare the granules, and a synthetic product can be optionally prepared in any manner by a known method.

The clay mineral has a particle size of preferably 1 μm or more, and more preferably 5 μm or more, from the viewpoint of dispersibility upon mixing the powdery raw materials. In addition, the clay mineral has a particle size of preferably 100 μm or less, and more preferably 50 μm or less, from the viewpoint of dispersibility in water.

The component B is contained in an amount of 60% by weight or less of the detergent builder granules. In addition, the component B is contained in an amount of preferably 20% by weight or more, more preferably 30% by weight or more, and especially preferably 40% by weight or more, from the viewpoint of low-temperature dispersibility. In addition, the component B is contained in an amount of preferably 55% by weight or less, more preferably 50% by weight or less, and especially preferably 45% by weight or less, from the viewpoint of detergent performance.

The component A and the component B are in a weight ratio, i.e. A/B, calculated as anhydrides, of 5/95 or more, preferably 20/80 or more, more preferably 30/70 or more, and even more preferably 40/60, from the viewpoint of detergent performance. The component A and the component B are in a weight ratio of 80/20 or less, preferably 70/30 or less, and more preferably 60/40 or less, from the viewpoint of low-temperature dispersibility.

The detergent builder granules of the present invention have a percentage of water loss upon heating the granules to 200° C., when measured according to the measurement method described in Examples, of 3% by weight or more, preferably 5% by weight or more, and more preferably 7% by weight or more, from the viewpoint of low-temperature dispersibility. In addition, the detergent builder granules have a percentage of water loss of 30% by weight or less, preferably 20% by weight or less, and more preferably 15% by weight or less, from the viewpoint of granulating property. Here, in order to adjust the percentage of water loss of the detergent builder granules of the present invention within the above-mentioned preferred range of the percentage of water loss, the detergent builder granules may be dried or subjected to moisture absorption treatment as occasion demands.

To the detergent builder granules of the present invention, a binder may be optionally added, for the purpose of increasing granular strength, within the range that would not hinder the low-temperature dispersibility. As the binder, a known hydrophilic binder can be used. The hydrophilic binder is exemplified by starch, dextrin, alginic acid, sodium alginate, gum arabic, casein, casein sodium, gelatin, carboxymethyl cellulose (CMC), methylcellulose (MC), hydroxyethyl cellulose (HEC), calcium ligninsulfonate, carboxymethyl starch (CMS), hydroxyethyl starch, phosphoric ester sodium, sodium silicate (water glass), glycerol, polyethylene glycol, polyvinyl alcohol (PVA), polyvinyl methyl ether (PVM), polyacrylic acid amide, sodium polyacrylate, polyethylene oxide, polyvinyl pyrrolidone (PVP), a nonionic surfactant, an anionic surfactant, a cationic surfactant, and an amphoteric surfactant. Among them, it is preferable to use sodium polyacrylate, water glass, and polyethylene glycol, and it is more preferable to use sodium polyacrylate, from the viewpoint of satisfying both the improvement in granular strength and the dispersibility.

It is preferable that the binder is added in the form of an aqueous solution. The preferred concentration of the aqueous binder solution is preferably from 1 to 40% by weight, more preferably from 3 to 30% by weight, and especially preferably from 5 to 20% by weight, from the viewpoint of handling upon spraying. In addition, it is preferable that the viscosity is from 1 to 800 cps or so. The measurement of the viscosity is carried out by a B-type viscometer (at 25° C.).

To the detergent builder granules of the present invention, a known water-soluble detergent formulating component may be added, within the range that would not hinder the low-temperature dispersibility, for the purpose of increasing granular strength. The water-soluble detergent formulating component includes, for example, organic builders such as nitrilotriacetic acid (NTA), and the like. The water-soluble detergent formulating component is contained in an amount of preferably 20% by weight or less, and more preferably 10% by weight or less, of the detergent builder granules, from the viewpoint of inhibiting bleed-out of the formulating component. In addition, a water-soluble functional drug is dissolved in water, and a solution obtained may be added during the production of the detergent builder granules of the present invention so that the solution is allowed to be contained, for the purpose of providing other functions to the detergent builder granules of the present invention. The water-soluble functional drug includes fluorescent brightening agents such as disodium 4,4′-bis(2-sulfostyryl)-biphenyl, and the like. The water-soluble functional drug is contained in an amount of preferably 20% by weight or less, and more preferably 10% by weight or less, of the detergent builder granules, from the viewpoint of inhibiting bleed-out of the functional drug.

The detergent builder granules of the present invention may contain a known oil agent, perfume, a water-insoluble inorganic compound or the like as a detergent formulation, for the purpose of enhancing granular strength, within the range so as not to hamper the low-temperature dispersibility. The oil agent, perfume, water-insoluble inorganic compound or the like is contained in an amount of preferably 20% by weight or less, and more preferably 10% by weight or less, of the detergent builder granules, from the viewpoint of inhibiting bleed-out. In addition, a water-insoluble functional drug may be dissolved in water and the solution may be added to the detergent builder granules of the present invention upon the production of the detergent builder granules of the present invention to allow the solution to be contained, for the purpose of providing other functions to the detergent builder granules of the present invention. The water-insoluble functional drug includes, for example, a defoaming such as dimethyl silicone, and the like. The water-insoluble functional drug is contained in the detergent builder granules in an amount of preferably 20% by weight or less, and more preferably 10% by weight or less, from the viewpoint of inhibiting bleed-out.

In the following method for producing the detergent builder granules of the present invention, a zeolite can be preferably added in a surface-modifying step, in which case it is preferred because the blocking of the detergent builder granules of the present invention can be inhibited. The zeolite is contained in a preferred amount of 0.5% by weight or more, and more preferably 1% by weight or more, of the detergent builder granules, from the viewpoint of blocking property. In addition, the zeolite is contained in an amount of preferably 10% by weight or less, and more preferably 6% by weight or less, of the detergent builder granules, from the viewpoint of free flowability of the granules.

The method for producing detergent builder granules of the present invention includes:
step 1. mixing the component A and the component B (the mixing step);
step 2. adding water (component C) to a mixture obtained in the step 1 to granulate a mixture obtained (the step of adding water to granulate); and
step 3. adding fine particles to a granular surface of granules obtained in the step 2 to surface-modify the granules (the surface-modifying step).

In addition, another method for producing detergent builder granules of the present invention includes a method including:
step a: mixing the component A and a part of the component B;
step b: adding water (the component C) to a mixture obtained in the step a to granulate a mixture obtained; and
step c: mixing the component B (a part or all of a remainder thereof) with granules obtained in the step b, and adding the component C to granulate a mixture obtained.
   This method may further includes:
step d: mixing the component B with granules obtained in the step c, and adding the component C to granulate a mixture obtained.

In the present invention, the component C is water.

The component C in the method for producing detergent builder granules of the present invention is added in an amount of preferably 3% by weight or more, more preferably 5% by weight or more, and especially preferably 9% by weight or more, from the viewpoint of low-temperature dispersibility. In addition, the component C is added in an amount of preferably 30% by weight or less, more preferably 20% by weight or less, and especially preferably 15% by weight or less, from the viewpoint of detergent performance.

The above-mentioned three steps may be individually carried out in separate apparatus; however, it is preferable that the three steps are carried out in the same apparatus including, for example, an agitation granulator, from the viewpoint of productivity.

As the agitation granulators used in the production of the detergent builder granules of the present invention, known granulation apparatus may be used. The agitation granulators include, for example, High-Speed Mixer and High-Flex Gralle, manufactured by Fukae Powtec Co., Ltd., Henschel mixer, Vertical Granulator manufactured by Powrex Corporation, APEX GRANULATORS and Ploughshare Mixers manufactured by PACIFIC MACHINERY & ENGINEERING Co., Ltd., Julia Mixer manufactured by TOKUJU CORPORATION, Lödige Mixer manufactured by Matsubo Co., Ltd., Intensive Mixer manufactured by Nippon Eirich CO., LTD., Marumerizer and PELLETER DOUBLE, manufactured by Fuji Paudal Co., Ltd., Twin Dome Gran manufactured by DALTON CORPORATION, FINE DISC PELLETER, Roller Compactor manufactured by Freund Corporation, Roller Compactor manufactured by TURBO KOGYO CO., LTD., BRIKETTA manufactured by SINTOKOGIO CO., LTD., Bricketting Machine manufactured by Hosokawa Micron Corporation, and the like. Among them, Lödige Mixer, Henschel Mixer, and Intensive Mixer are preferred, and Intensive Mixer is especially preferable, from the viewpoint of maintaining dissolubility of the detergent builder granules.

According to the above method, the detergent builder granules of the present inventions are obtained, and first, the mixing of the component A and the component B in the step 1 is important in order to improve low-temperature dispersibility. One of the causations of the lowering of low-temperature dispersibility is considered to be incurred by dissolving and unifying the component A in a low-temperature water, thereby forming a film of hydrate crystals. Therefore, the component A and the component B are mixed so that the granules can be present in the form in which the component B which is insoluble in water but has high dispersibility in water is interposed between the granules of the component A. By mixing in the above manner, it is considered that the unification of the component A in a low-temperature water is prevented, and the re-dispersion in water is improved. In addition, the addition of the component C in the step 2 is for the purpose of utilizing the property of allowing a component B to absorb water, thereby swelling the granules to increase their viscosity, and the component C is added for utilizing the component B as a binder for the granulation. For the purpose of further supplementing the binding ability of the component B, if a different binder is dissolved in a component C to be added, it is preferred because granules having even higher granular strength are formed. In addition, a part of the component C to be added is not only absorbed in the component B but also in the component A, so that the component C is also utilized in converting a part of the component A into a hydrate. It is considered that the effects of Patent Publications 2 and 3 are exhibited in the manner as described above. The step 3 is carried out to provide surfaces of wet granules obtained in the step 2 with a dry texture, thereby modifying the granules to give high free flowability; for this purpose, it is preferable to use the fine particles having water absorbency. The preferred fine particles having water absorbency are the component B, and it is preferable to use the component B as a surface-modifying agent from the viewpoint of controlling the number of raw material species to a minimal limit. Also, besides the component B, zeolite that gives similar effects may also be used. By covering the surface with the surface-modifying agent as described above, the component A can be locked into the detergent builder granules, so that low-temperature dispersibility can be improved.

Further, as a method of locking the component A into the detergent builder granules, for example, the method including the steps a to c is considered. Further, by repeating the step d, the component A can be tightly locked into the detergent builder granules, with the component B, so that low-temperature dispersibility can be improved. However, it is desired that the number of repeats is 4 times or less, from the viewpoint of productivity.

In addition, if a chloride is used as the component A, dispersibility of the component B in water can be improved, so that low-temperature dispersibility can be even more enhanced.

The detergent builder granules of the present invention have an average particle size determined by the measurement method described in Examples, of preferably 200 μm or more, more preferably 300 μm or more, and especially preferably 400 μm or more, from the viewpoint of free flowability. Also, the detergent builder granules have an average particle size of preferably 1000 μm or less, more preferably 800 μm or less, and especially preferably 600 μm or less, from the viewpoint of dissolubility.

The detergent builder granules of the present invention have a bulk density determined by the measurement method described in Examples, of preferably 500 g/L or more, more preferably 600 g/L or more, and especially preferably 800 g/L or more, from the viewpoint of compactness to the detergent. In addition, the detergent builder granules have a bulk density of or preferably 1500 g/L or less, more preferably 1300 g/L or less, and especially preferably 1200 g/L or less, from the viewpoint of dissolubility.

In the low-temperature dispersibility of the detergent builder granules of the present invention, the evaluation criteria, in the measurement method described in Examples, in which I and II are judged to be favorable for conditions of 5° C. for 3 minutes, or the evaluation criteria in which Ito III are judged to be favorable for conditions of 5° C. for 5 minutes can be used.

The detergent builder granules of the present invention have a dissolution ratio determined by the measurement method described in Examples of preferably 70% or more, more preferably 80% or more, and especially preferably 85% or more.

Although the applications for the detergent builder granules of the present invention are not particularly limited, the detergent builder granules can be utilized in laundry detergents, dishware detergents, household detergents, automobile detergents, body detergents, dentifrice, additives to detergents for metals, and especially it is preferable that the detergent builder granules are used in laundry detergents.

The detergent composition of the present invention has a feature in that the detergent composition contains the detergent builder granules of the present invention. The detergent composition can be prepared by previously preparing detergent builder granules, and mixing detergent builder granules obtained with a detergent.

The detergent builder granules are contained in an amount of preferably 5% by weight or more, and more preferably 10% by weight or more, of the detergent composition, from the viewpoint of improving low-temperature dispersibility of the detergent. In addition, the detergent builder granules are contained in an amount of preferably 70% by weight or less, and more preferably 60% by weight or less, from the viewpoint of detergent performance.

Besides the detergent builder granules of the present invention, the detergent composition of the present invention is formulated with a surfactant, a builder, an enzyme, a bleaching agent, a redeposition preventing agent, a softening agent, a reducing agent (a sulfite or the like), a fluorescent brightener, a defoaming agent (a silicone or the like), a perfume, or the like, that is ordinarily formulated in a laundry detergent or the like.

A mixer to be used for mixing the detergent builder granules of the present invention with a detergent to prepare a detergent composition is not limited in the kinds so long as the detergent builder granules of the present invention and detergent granules can be homogeneously mixed, and, for example, a horizontal cylindrical mixer or a V type mixer, an agitation granulator, or a tumbling granulator can be used.

### EXAMPLES

### 1. Average Particle Size of Detergent Builder Granules

Using nine-stage sieves having sieve-openings of 125 μm, 180 μm, 250 μm, 355 μm, 500 μm, 710 μm, 1000 μm, 1400 μm, and 2000 μm, and a receiving tray, the sieves were stacked from a sieve having a smaller sieve opening on the receiving tray, 100 g of detergent builder granules of Table 1 was added from the top sieve having a sieve-opening of 2000 μm, the stacked sieves were covered, attached to a rotating and tapping shaker machine (manufactured by HEIKO SEISAKUSHO, tapping: 156 times/min, rolling: 290 times/min), and vibrated for 5 minutes to be classified. Thereafter, the weights of the granules remaining on each of the sieves and the receiving tray were determined, and a weight percentage (%) of the granules on each sieve was calculated. The weight percentages of the granules on the sieves in order from smaller sizes in sieve-openings, starting from the receiving tray were accumulated, and a particle size corresponding to a total weight percentage of the particles at 50% is defined as an average particle size.

### 2. Bulk Density

The bulk density of the detergent builder granules of Table 1 was measured according to JIS K3362 (density).

### 3. Percentage of Water Loss

### Water Content

Five grams of the detergent builder granules of Table 1 were heated from the initial state (25° C., 40% RH) to 200° C. with an infrared moisture meter (FD-240, manufactured by Kett Electric Laboratory), and a total percentage of weight loss until the weight was kept at a constant level for 3 seconds is defined as a percentage of water loss.

### 4. Low-Temperature Dispersibility

The amount 17.5 g of detergent builder granules of Table 1, a detergent of Table 2, or a detergent composition containing a detergent of Table 2 and detergent builder granules of Example 3, Example 16, or Example 20 was placed, in a massive state near the outer periphery of one of the dents of a sector, a six-divided section of a pulsator of a washing machine AISAIGO NA-F42Y1 manufactured by Matsushita Electric Industrial Co., Ltd. The amount 1.5 kg of clothes were introduced to the washtub without disintegrating the mass, and 21 L of tap water was poured thereto at a flow rate of 10 L/min in a manner so that the water did not directly hit the detergent builder granules of Table 1, the detergent of Table 2, or the detergent composition containing a detergent of Table 2 and detergent builder granules of Example 3, Example 16, or Example 20. After the termination of water-pouring, it was allowed to stand. The low-temperature dispersibility was determined by initiating agitation for 3 minutes with gentle water current (hand-washing mode) after 3 minutes from the beginning of water-pouring for the detergent builder granules of Table 1, or after 3 minutes or 5 minutes from the beginning of water-pouring for the detergent of Table 2, or the detergent composition containing the detergent of Table 2 and the detergent builder granules of Example 3, Example 16, or Example 20 (Table 3); discharging water from the washtub; and visually examining the state of the detergent builder granules of Table 1, the detergent of Table 2, or the detergent composition containing a detergent of Table 2 and detergent builder granules of Example 3, Example 16, or Example 20 that remain on the clothes and the washtub according to the following evaluation criteria. The agitation force of this evaluation is much weaker than that of the standard, and the evaluation criteria of I and II are judged to be excellent for low-temperature dispersibility under conditions of 5° C. for 3 minutes, and the evaluation criteria of Ito III are judged to be excellent for low-temperature dispersibility under conditions for 5° C. for 5 minutes. In addition, the word “aggregates” as used below refers to collective bodies of the detergent builder granules of Table 1, the detergent of Table 2, or the detergent composition containing a detergent of Table 2 and detergent builder granules of Example 3, Example 16, or Example 20 that are aggregated to a diameter of 3 mm or more.

### [Evaluation Criteria]

I: No aggregates;
II: Substantially no aggregates (1 to 5 masses having a diameter of about 3 mm being found);
III: Aggregates remain in small amounts (masses having a diameter of about 6 mm being found, and 10 or less masses having a diameter of from 3 to 10 mm being found); and
IV: Aggregates remaining in large amounts (a large number of masses having a diameter exceeding 6 mm being found).

### 5. Dissolution Ratio

A 1-L beaker (a cylindrical form having an inner diameter of 105 mm and a height of 150 mm, for example, a 1-L glass beaker manufactured by Iwaki Glass Co., Ltd.) is charged with 1 L of hard water cooled to 5° C. and having a water hardness equivalent to 71.2 mg CaCO₃/L (molar ratio: Ca/Mg:7/3). While keeping the water temperature constant at 5° C. with a water bath, water is stirred with a stirring bar [length: 35 mm and diameter: 8 mm, for example, Model: TEFLON (registered trademark) MARUGATA-HOSOGATA, manufactured by ADVANTEC] at a rotational speed such that a depth of swirling to the water depth is about ⅓ (800 rpm). The detergent builder granules of Table 1 which are accurately weighed so as to be 0.8333 g±0.0010 g are supplied and dispersed in water while stirring, and the dispersion is continued stirring. After 60 seconds from supplying the granules, a liquid dispersion of the detergent builder granules in the beaker is filtered with a standard sieve (diameter: 100 mm) having a sieve-opening of 74 μm according to JIS Z 8801 (corresponding to ASTM No. 200) of a known weight. Thereafter, water-containing detergent builder granules remaining on the sieve are collected in an open vessel of a known weight together with the sieve. Here, the operation time from the beginning of filtration to collection of the sieve is 10 sec±2 sec. The collected insoluble remnants of the detergent builder granules are dried for one hour with an electric dryer heated to 105° C. Thereafter, the dried insoluble remnants are kept in a desiccator with a silica gel (25° C.) for 30 minutes and cooled. After cooling, a total weight of the dried insoluble remnants of the detergent builder granules, the sieve, and the vessel is measured. Thereafter, the dissolution ratio (%) of the detergent builder granules is calculated by the following formula (I). Here, the weight is measured with a precision balance.

Dissolution Ratio (%)={1−(T/S)}×100 (1)

wherein S is a weight (g) of the detergent builder granules supplied; and T is a dry weight (g) of the insoluble remnants of the detergent builder granules remaining on the sieve, when the aqueous solution obtained under the above-mentioned stirring conditions is subjected to sieving.

### 6. X-Ray Diffraction Spectrum

The X-ray diffraction spectrum of the detergent builder granules was determined with an X-ray diffractometer RINT 2500VPC, manufactured by Rigaku Corporation at voltage of 40 kV, and an electric current of 120 mA in the range of 2θ=5° to 50°.

### 7. Elemental Analysis with SEM

Detergent builder granules are embedded into a resin, and their cross sections were sliced with ULTRAMICROTOME (manufactured by LEICA). The thin slices obtained were observed with a scanning electron microscope (S4800 manufactured by Hitachi, Ltd.), and subjected to elemental analysis according to EDS.

### Example 1

Fifty parts by weight of granular sodium carbonate (manufactured by Central Glass Co., Ltd.) having an average particle size of 269 μm and 20 parts by weight of bentonite (DETERSOFT, manufactured by Laviosa) having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 10 parts by weight of a 10% by weight aqueous sodium polyacrylate solution (manufactured by Kao Corporation, molecular weight: 10000) was added thereto. Thereafter, in order to carry out surface modification, 26 parts by weight of the bentonite was additionally added thereto, and the mixture was agitated for one minute, to provide detergent builder granules. The physical properties of the resulting detergent builder granules are shown in Table 1.

### Example 2

Thirty-five parts by weight of granular sodium carbonate (manufactured by Central Glass Co., Ltd.) having an average particle size of 269 μm, 15 parts by weight of sodium sulfate (manufactured by Shikoku Kasei) having an average particle size of 165 μm, and 20 parts by weight of bentonite (DETERSOFT, manufactured by Laviosa) having an average particle size of 12 μm were added to Intensive Mixer (R02-VAC, manufactured by Eirich), and subsequently the same procedures as in Example 1 were carried out, to provide detergent builder granules. The physical properties of the resulting detergent builder granules are shown in Table 1.

### Example 3

The same procedures as in Example 2 were carried out except that the amount of the granular sodium carbonate was 25 parts by weight and the amount of the sodium sulfate was 25 parts by weight, to provide detergent builder granules. The physical properties of the resulting detergent builder granules are shown in Table 1.

The X-ray diffraction spectrum of the detergent builder granules of Example 3 is shown in FIG. 1. X-ray diffractions patterns ascribed to sodium carbonate decahydrate, hydrate crystals of sodium carbonate, and sodium sesquicarbonate were found besides those of sodium carbonate, sodium sulfate, and bentonite, which were the raw materials.

In addition, a cross section of the detergent builder granules of Example 3 was subjected to elemental analysis according to SEM-EDS (FIG. 2). As a result, it was observed that the water-soluble inorganic salt having and/or capable of forming hydrate crystals of granular sodium carbonate or sodium sulfate was homogeneously dispersed in a state showing an islands-sea structure in the bentonite, in which the bentonite was interposed between granules of the water-soluble inorganic salt.

### Example 4

The same procedures as in Example 2 were carried out except that the amount of the granular sodium carbonate was 15 parts by weight and the amount of the sodium sulfate was 35 parts by weight, to provide detergent builder granules. The physical properties of the resulting detergent builder granules are shown in Table 1.

### Example 5

The same procedures as in Example 1 were carried out except that the sodium sulfate was added in an amount of 50 parts by weight in place of the granular sodium carbonate, to provide detergent builder granules. The physical properties of the resulting detergent builder granules are shown in Table 1.

### Example 6

The same procedures as in Example 3 were carried out except that 4 parts by weight of zeolite having an average particle size of 5 μm was added to 26 parts by weight of the bentonite for surface modification, to provide detergent builder granules. The physical properties of the resulting detergent builder granules are shown in Table 1.

### Example 7

The same procedures as in Example 3 were carried out except that water was used in place of the 10% by weight aqueous polyacrylate solution, to provide detergent builder granules. The physical properties of the resulting detergent builder granules are shown in Table 1.

### Example 8

The same procedures as in Example 3 were carried out except that a 10% by weight aqueous sodium silicate solution (one prepared by diluting JIS No. 2 Water Glass, manufactured by Nippon Chemical Industry Co., LTD. with water) was used in place of the 10% by weight aqueous polyacrylate solution, to provide detergent builder granules. The physical properties of the resulting detergent builder granules are shown in Table 1.

### Example 9

The same procedures as in Example 3 were carried out except that a 10% by weight aqueous polyethylene glycol solution (one prepared by diluting XG-3000, manufactured by MITSUI CHEMICALS, INC. with water) was used in place of the 10% by weight aqueous polyacrylate solution, to provide detergent builder granules. The physical properties of the resulting detergent builder granules are shown in Table 1.

### Example 10

The same procedures as in Example 3 were carried out except that the amount of the granular sodium carbonate was 30 parts by weight, the amount of the sodium sulfate was 30 parts by weight, and the total amount of the bentonite was 30 parts by weight (out of which 25 parts by weight was added for modification), and that water was used in place of the 10% by weight aqueous polyacrylate solution, to provide detergent builder granules. The physical properties of the resulting detergent builder granules are shown in Table 1.

### Example 11

The detergent builder granules obtained in Example 3 were dried with an electric dryer at 60° C. until a percentage of water loss reached the value shown in Table 1 (10 minutes). The percentage of water loss was measured with a moisture meter as mentioned above. In this example, a drying time for obtaining granules having a desired percentage of water loss was determined by a method of charging granules having a water content of about 12% by weight in an electric dryer at 60° C., sampling at an appropriate time, and checking a percentage of water loss with a moisture meter. Detergent builder granules obtained by drying the detergent builder granules of Example 3 for a given drying time period are provided as detergent builder granules of this example. The physical properties of the resulting detergent builder granules are shown in Table 1. The detergent builder granules were also provided in the same manner for Examples 12 to 18 and Comparative Examples 1, 2, 6, and 7 given below. Here, the water content in a case where the granules were heated at 200° C. and kept for 60 minutes was 0. Regarding Examples 19 to 21, the percentage of water loss of the detergent builder granules was determined according to the same procedures using a fluidized bed at 100° C. set forth later.

### Example 12

The detergent builder granules obtained in Example 3 were dried with an electric dryer at 60° C. until a percentage of water loss reached the value shown in Table 1 (20 minutes). The physical properties of the resulting detergent builder granules are shown in Table 1.

### Example 13

The detergent builder granules obtained in Example 5 were dried with an electric dryer at 60° C. until a percentage of water loss reached the value shown in Table 1 (20 minutes). The physical properties of the resulting detergent builder granules are shown in Table 1.

### Example 14

Thirty-six parts by weight of the granular sodium carbonate having an average particle size of 269 μm, 36 parts by weight of the sodium sulfate having an average particle size of 165 μm, and 10 parts by weight of the bentonite having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 10 parts by weight of the 10% by weight aqueous sodium polyacrylate solution was added thereto. Thereafter, in order to carry out surface modification, 14 parts by weight of the bentonite was additionally added thereto, and the mixture was agitated for one minute. The granules obtained were dried with an electric dryer at 60° C. until a percentage of water loss reached the value shown in Table 1 (10 minutes), to provide detergent builder granules. The physical properties of the resulting detergent builder granules are shown in Table 1.

### Example 15

Forty-seven parts by weight of the sodium sulfate having an average particle size of 165 μm, 5 parts by weight of sodium chloride (table salt Nakuru N, manufactured by Naikai Salt Industries Co., LTD.) having an average particle size of 360 μm, and 10 parts by weight of the bentonite having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 10 parts by weight of the 10% by weight aqueous sodium polyacrylate solution was added thereto. Thereafter, in order to carry out surface modification, 37 parts by weight of the bentonite was additionally added thereto, and the mixture was agitated for one minute. The granules obtained were dried with an electric dryer at 60° C. until a percentage of water loss reached the value shown in Table 1 (20 minutes), to provide detergent builder granules. The physical properties of the resulting detergent builder granules are shown in Table 1.

### Example 16

The same procedures as in Example 15 were carried out except that the amount of the sodium sulfate was 31 parts by weight, and the amount of the sodium chloride was 21 parts by weight, to provide detergent builder granules. The physical properties of the resulting detergent builder granules are shown in Table 1.

### Example 17

The same procedures as in Example 16 were carried out except that 13 parts by weight of the 10% by weight aqueous sodium silicate solution was added in place of the 10% by weight aqueous sodium polyacrylate solution, to provide detergent builder granules. The physical properties of the resulting detergent builder granules are shown in Table 1.

### Example 18

Fifty-two parts by weight of the sodium chloride having an average particle size of 360 μm and 10 parts by weight of the bentonite having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 9 parts by weight of the 10% by weight aqueous sodium silicate solution was added thereto. Thereafter, in order to carry out surface modification, 37 parts by weight of the bentonite was additionally added thereto, and the mixture was agitated for one minute. The granules obtained were dried with an electric dryer at 60° C. until a percentage of water loss reached the value shown in Table 1 (20 minutes), to provide detergent builder granules. The physical properties of the resulting detergent builder granules are shown in Table 1.

### Example 19

Fifty parts by weight of the sodium sulfate having an average particle size of 165 μm and 10 parts by weight of bentonite having an average particle size of 20 μm and a water content of 8% by weight were added to Intensive Mixer (R02-VAC, manufactured by Eirich), and the components were mixed at a rotational speed of the rotor of 1680 rpm and a panning rotational speed of 45 rpm for one minute. Next, 5 parts by weight of the 10% by weight aqueous sodium polyacrylate solution was added thereto, and thereafter the components were agitated for one minute in order to carry out the granulation. Next, in order to carry out a coating, 12 parts by weight of the bentonite was added thereto, and the components agitated for one minute. Next, 3 parts by weight of the 10% by weight aqueous sodium polyacrylate solution was added thereto, and thereafter the components were agitated for one minute in order to carry out the granulation. Next, in order to carry out a second coating, 12 parts by weight of the bentonite was additionally added thereto, and the components were agitated for one minute. Next, 3 parts by weight of the 10% by weight aqueous sodium polyacrylate solution was added thereto, and thereafter the components were agitated for one minute in order to carry out the granulation. Next, in order to carry out a third coating, 12 parts by weight of the bentonite was added thereto, and the components were agitated for one minute. Finally, in order to firmly adhere the surface-coated bentonite to the granules, 4 parts by weight of the 10% by weight aqueous sodium polyacrylate solution was added, and the components were agitated for 4 minutes. The granules obtained were dried with a fluidized bed (Slit Flow FBS-1, manufactured by OKAWARA MFG. Co., LTD.) at 100° C. until a percentage of water loss reached the value shown in Table 1 (4 minutes). Next, the detergent builder granules obtained were classified with a sieve having a size of 1180 μm (Gyro Sifter, manufactured by TOKUJU CORPORATION), those granules that are oversized, i.e. the granules having sizes of 1180 μm or more, were pulverized with a pulverizer (Fitz Mill, manufactured by Hosokawa Micron Corporation), and the pulverized product was mixed with 1180 μm-sieve-passed granules, to provide detergent builder granules. The physical properties of the resulting detergent builder granules are shown in Table 1.

### Example 20

Fifty parts by weight of the sodium sulfate having an average particle size of 165 μm and 10 parts by weight of the bentonite having an average particle size of 20 μm and a water content of 8% by weight were added to Intensive Mixer (R02-VAC, manufactured by Eirich), and the components were mixed at a rotational speed of the rotor of 3300 rpm and a panning rotational speed of 45 rpm for one minute. Next, 5 parts by weight of the 40% by weight aqueous sodium polyacrylate solution was added thereto, and thereafter the components were agitated for one minute in order to carry out the granulation. Next, in order to carry out a coating, 12 parts by weight of the bentonite was added thereto, and the components agitated at a rotational speed of the rotor of 1650 rpm and a panning rotational speed of 45 rpm for one minute. Next, 3 parts by weight of the 40% by weight aqueous sodium polyacrylate solution was added thereto, and thereafter the components were agitated for one minute in order to carry out the granulation. Next, in order to carry out a second coating, 12 parts by weight of the bentonite was additionally added thereto, and the components were agitated for one minute. Next, 3 parts by weight of the 40% by weight aqueous sodium polyacrylate solution was added thereto, and thereafter the components were agitated for one minute in order to carry out the granulation. Next, in order to carry out a third coating, 12 parts by weight of the bentonite was added thereto, and the components were agitated for one minute. Finally, in order to firmly adhere the surface-coated bentonite to the granules, 3 parts by weight of the 40% by weight aqueous sodium polyacrylate solution was added, and the components were agitated for 3 minutes. The granules obtained were dried with a fluidized bed (Slit Flow FBS-1, manufactured by OKAWARA MFG. Co., LTD.) at 100° C. until a percentage of water loss reached the value shown in Table 1 (4 minutes). Next, the detergent builder granules obtained were classified with a sieve having a size of 1180 μm (Gyro Sifter, manufactured by TOKUJU CORPORATION), those granules that are oversized, i.e. the granules having sizes of 1180 μm or more, were pulverized with a pulverizer (Fitz Mill, manufactured by Hosokawa Micron Corporation), and the pulverized product was mixed with 1180 μm-sieve-passed granules, to provide detergent builder granules. The physical properties of the resulting detergent builder granules are shown in Table 1.

### Example 21

Forty-five parts by weight of the sodium sulfate having an average particle size of 165 μm, 7 parts by weight of the sodium chloride having an average particle size of 360 μm, and 10 parts by weight of the bentonite having an average particle size of 20 μm and a water content of 8% by weight were added to Intensive Mixer (R02-VAC, manufactured by Eirich), and the components were mixed at a rotational speed of the rotor of 3300 rpm and a panning rotational speed of 45 rpm for one minute. Next, 4 parts by weight of the 10% by weight aqueous sodium polyacrylate solution was added thereto, and thereafter the components were agitated for one minute in order to carry out the granulation. Next, in order to carry out a coating, 12 parts by weight of the bentonite was added thereto, and the components agitated for one minute. Next, 2 parts by weight of the 10% by weight aqueous sodium polyacrylate solution was added thereto, and thereafter the components were agitated for one minute in order to carry out the granulation. Next, in order to carry out a second coating, 12 parts by weight of the bentonite was additionally added thereto, and the components were agitated for one minute. Next, 2 parts by weight of the 10% by weight aqueous sodium polyacrylate solution was added thereto, and thereafter the components were agitated for one minute in order to carry out the granulation. Next, in order to carry out a third coating, 12 parts by weight of the bentonite was added thereto, and the components were agitated for one minute. Finally, in order to firmly adhere the surface-coated bentonite to the granules, 2 parts by weight of the 10% by weight aqueous sodium polyacrylate solution was added, and the components were agitated for 3 minutes. The granules obtained were dried with a fluidized bed (Slit Flow FBS-1, manufactured by OKAWARA MFG. Co., LTD.) at 100° C. until a percentage of water loss reached the value shown in Table 1 (4 minutes). Next, the detergent builder granules obtained were classified with a sieve having a size of 1180 μm (Gyro Sifter, manufactured by TOKUJU CORPORATION), those granules that are oversized, i.e. the granules having sizes of 1180 μm or more, were pulverized with a pulverizer (Fitz Mill, manufactured by Hosokawa Micron Corporation), and the pulverized product was mixed with 1180 μm-sieve-passed granules, to provide detergent builder granules. The physical properties of the resulting detergent builder granules are shown in Table 1.

### Comparative Example 1

The detergent builder granules obtained in Example 3 were dried with an electric dryer at 200° C. until a percentage of water loss reached the value shown in Table 1 (5 minutes). The physical properties of the resulting detergent builder granules are shown in Table 1.

### Comparative Example 2

The detergent builder granules obtained in Example 5 were dried with an electric dryer at 200° C. until a percentage of water loss reached the value shown in Table 1 (5 minutes). The physical properties of the resulting detergent builder granules are shown in Table 1.

### Comparative Example 3

The same procedures as in Example 7 were carried out except that the amount of the sodium carbonate was 3 parts by weight and the amount of the bentonite was 97 parts by weight (out of which 23 parts by weight was added for modification), to provide detergent builder granules. The physical properties of the resulting detergent builder granules are shown in Table 1.

### Comparative Example 4

Twenty-five parts by weight of granular sodium carbonate (manufactured by Central Glass Co., Ltd.) having an average particle size of 269 μm and 25 parts by weight of sodium sulfate (manufactured by Shikoku Kasei) having an average particle size of 165 μm were added to Intensive Mixer (R02-VAC, manufactured by Eirich), and 10 parts by weight of water was added thereto to granulate a mixture obtained without using bentonite, to provide detergent builder granules. The physical properties of the resulting detergent builder granules are shown in Table 1.

### Comparative Example 5

Fifty parts by weight of granular sodium carbonate (manufactured by Central Glass Co., Ltd.) having an average particle size of 269 μm was added to Intensive Mixer (R02-VAC, manufactured by Eirich), and 10 parts by weight of water was added thereto to granulate a mixture obtained to provide detergent builder granules. The physical properties of the resulting detergent builder granules are shown in Table 1.

### Comparative Example 6

Five parts by weight of the granular sodium carbonate having an average particle size of 269 μm, 5 parts by weight of the sodium sulfate having an average particle size of 165 μm, and 64 parts by weight of the bentonite having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 10 parts by weight of the 10% by weight aqueous sodium polyacrylate solution was added thereto. Thereafter, in order to carry out surface modification, 26 parts by weight of the bentonite was additionally added thereto, and the mixture was agitated for one minute. The granules obtained were dried with an electric dryer at 60° C. until a percentage of water loss reached the value shown in Table 1 (20 minutes), to provide detergent builder granules. The physical properties of the resulting detergent builder granules are shown in Table 1.

### Comparative Example 7

Thirteen parts by weight of the granular sodium carbonate having an average particle size of 269 μm, 13 parts by weight of the sodium sulfate having an average particle size of 165 μm, and 48 parts by weight of the bentonite having an average particle size of 12 μm and a water content of 12% by weight were added to Intensive Mixer (R02-VAC, manufactured by Eirich), and the components were mixed at a rotational speed of the rotor of 1680 rpm and a panning rotational speed of 45 rpm for one minute. Next, 10 parts by weight of the 10% by weight aqueous sodium polyacrylate solution was added thereto. Thereafter, in order to carry out surface modification, 26 parts by weight of the bentonite was additionally added thereto, and the mixture was agitated for one minute. The granules obtained were dried with an electric dryer at 60° C. until a percentage of water loss reached the value shown in Table 1 (20 minutes), to provide detergent builder granules. The physical properties of the resulting detergent builder granules are shown in Table 1.

### Test Example 1

The detergent builder granules of Examples 1 to 21 and Comparative Examples 1 to 7 were subjected to a test for low-temperature dispersibility at 5° C. for 3 minutes. The results are shown in Table 1. The detergent builder granules of Examples 1 to 21 showed excellent low-temperature dispersibility at 5° C. for 3 minutes, as compared to those of Comparative Examples 1 to 5. The detergent builder granules of Comparative Examples 6 and 7 had low-temperature dispersibility at 5° C. for 3 minutes of II, but their dissolution ratios were at low values of less than 80%. It was clarified from the comparisons between Example 12 and Comparative Example 1 and between Example 13 and Comparative Example 2, low-temperature dispersibility was excellent in a case where a percentage of water loss was high and low-temperature dispersibility was not favorable in a case where a percentage of water less was low, with a borderline of a percentage of water loss of about 3% by weight.

TABLE 1

| | Formulation Ratio (Parts by Weight) of Raw Materials | | | | | | | |
|---|---|---|---|---|---|---|---|---|
| | Component A | | | | | | | |
| | Sodium | Sodium | Sodium | Component B | Component C | Binder Component | | Other |
| | Carbonate | Sulfate | Chloride | Bentonite | Water | Binder | Amount | Component |
| Ex. 1 | 50 | 0 | 0 | 46 | 9 | Polyacrylate Na | 1 | 0 |
| Ex. 2 | 35 | 15 | 0 | 46 | 9 | Polyacrylate Na | 1 | 0 |
| Ex. 3 | 25 | 25 | 0 | 46 | 9 | Polyacrylate Na | 1 | 0 |
| Ex. 4 | 15 | 35 | 0 | 46 | 9 | Polyacrylate Na | 1 | 0 |
| Ex. 5 | 0 | 50 | 0 | 46 | 9 | Polyacrylate Na | 1 | 0 |
| Ex. 6 | 25 | 25 | 0 | 46 | 9 | Polyacrylate Na | 1 | 4* |
| Ex. 7 | 25 | 25 | 0 | 46 | 10 | — | — | 0 |
| Ex. 8 | 25 | 25 | 0 | 46 | 9 | Water Glass | 1 | 0 |
| Ex. 9 | 25 | 25 | 0 | 46 | 9 | PEG | 1 | 0 |
| Ex. 10 | 30 | 30 | 0 | 30 | 10 | — | — | 0 |
| Ex. 11 | 25 | 25 | 0 | 46 | 9 | Polyacrylate Na | 1 | 0 |
| Ex. 12 | 25 | 25 | 0 | 46 | 9 | Polyacrylate Na | 1 | 0 |
| Ex. 13 | 0 | 50 | 0 | 46 | 9 | Polyacrylate Na | 1 | 0 |
| Ex. 14 | 36 | 36 | 0 | 24 | 9 | Polyacrylate Na | 1 | 0 |
| Ex. 15 | 0 | 47 | 5 | 47 | 9 | Polyacrylate Na | 1 | 0 |
| Ex. 16 | 0 | 31 | 21 | 47 | 9 | Polyacrylate Na | 1 | 0 |
| Ex. 17 | 0 | 31 | 21 | 47 | 11.7 | Water Glass | 1.3 | 0 |
| Ex. 18 | 0 | 0 | 52 | 47 | 8.1 | Water Glass | 0.9 | 0 |
| Ex. 19 | 0 | 50 | 0 | 46 | 13.5 | Polyacrylate Na | 1.5 | 0 |
| Ex. 20 | 0 | 50 | 0 | 46 | 8.4 | Polyacrylate Na | 5.6 | 0 |
| Ex. 21 | 0 | 45 | 7 | 46 | 9 | Polyacrylate Na | 1 | 0 |
| Comp. Ex. 1 | 25 | 25 | 0 | 46 | 9 | Polyacrylate Na | 1 | 0 |
| Comp. Ex. 2 | 0 | 50 | 0 | 46 | 9 | Polyacrylate Na | 1 | 0 |
| Comp. Ex. 3 | 3 | 0 | 0 | 97 | 10 | — | — | 0 |
| Comp. Ex. 4 | 25 | 25 | 0 | 0 | 10 | — | — | 0 |
| Comp. Ex. 5 | 50 | 0 | 0 | 0 | 10 | — | — | 0 |
| Comp. Ex. 6 | 5 | 5 | 0 | 90 | 10 | Polyacrylate Na | 1 | 0 |
| Comp. Ex. 7 | 13 | 13 | 0 | 74 | 9 | Polyacrylate Na | 1 | 0 |

| | Physical Properties of Detergent Builder Granules | | | | | | | |
|---|---|---|---|---|---|---|---|---|
| | | | | | | Percentage | | |
| | | | | | | of | | |
| | | | | | | Water | | Low- |
| | Total | Content of | | Average | Bulk | Loss | Dissoution | Temperature |
| | Amount | Component B | | Particle Size | Density | (% by | Ratio | Dispersiblity |
| | Formulated | (% by wt.) | A/B | (micrometer) | (g/L) | wt.) | (%) | 5° C., 3 min. |
| Ex. 1 | 106 | 43.4 | 50/46 | 415 | 970 | 13.42 | 99.1 | II |
| Ex. 2 | 106 | 43.4 | 50/46 | 462 | 998 | 12.82 | 97.1 | II |
| Ex. 3 | 106 | 43.4 | 50/46 | 447 | 995 | 12.83 | 98.4 | I |
| Ex. 4 | 106 | 43.4 | 50/46 | 424 | 987 | 13.02 | 98.7 | I |
| Ex. 5 | 106 | 43.4 | 50/46 | 432 | 1004 | 12.37 | 93.3 | I |
| Ex. 6 | 110 | 41.8 | 50/46 | 425 | 982 | 13.56 | 93.9 | I |
| Ex. 7 | 106 | 43.4 | 50/46 | 664.6 | 926 | 14.93 | 89.6 | I |
| Ex. 8 | 106 | 43.4 | 50/46 | 346 | 916 | 14.22 | 97.9 | I |
| Ex. 9 | 106 | 43.4 | 50/46 | 381 | 909 | 14.62 | 90.4 | I |
| Ex. 10 | 100 | 30.0 | 60/30 | 489 | 935 | 11.2 | 86.2 | I |
| Ex. 11 | 106 | 43.4 | 50/46 | 447 | 995 | 9.5 | 82.3 | I |
| Ex. 12 | 106 | 43.4 | 50/46 | 447 | 993 | 3.8 | 88.6 | II |
| Ex. 13 | 106 | 43.4 | 50/46 | 428 | 1015 | 3.8 | 99.6 | II |
| Ex. 14 | 106 | 22.6 | 75/25 | 445 | 990 | 9.5 | 81.5 | II |
| Ex. 15 | 109 | 43.1 | 52/47 | 452 | 1180 | 4.8 | 95 | I |
| Ex. 16 | 109 | 43.1 | 52/47 | 401 | 1180 | 4.4 | 96.2 | I |
| Ex. 17 | 112 | 42.0 | 52/47 | 424 | 1176 | 3.7 | 99.9 | I |
| Ex. 18 | 108 | 43.5 | 52/47 | 445 | 1100 | 5.25 | 97.6 | I |
| Ex. 19 | 111 | 41.4 | 50/46 | 389 | 1136 | 4.9 | 91.8 | I |
| Ex. 20 | 110 | 41.8 | 50/46 | 388 | 1291 | 4.3 | 93 | I |
| Ex. 21 | 108 | 42.6 | 52/46 | 483 | 1152 | 3.8 | 89.8 | I |
| Comp. Ex. 1 | 106 | 43.4 | 50/46 | 447 | 992 | 1.14 | 86.0 | III |
| Comp. Ex. 2 | 106 | 43.4 | 50/46 | 415 | 1045 | 2.66 | 95.1 | III |
| Comp. Ex. 3 | 110 | 88.2 | 3/97 | 630 | 863 | 27.2 | 98.4 | III |
| Comp. Ex. 4 | 60 | 0.0 | 100/0 | 390 | 972 | 10.8 | 95.2 | IV |
| Comp. Ex. 5 | 60 | 0.0 | 100/0 | 385 | 790 | 10.5 | 95 | IV |
| Comp. Ex. 6 | 111 | 81.1 | 10/90 | 700 | 635 | 8 | 75.7 | II |
| Comp. Ex. 7 | 110 | 67.3 | 26/74 | 636 | 724 | 8 | 77.2 | II |

*Zeolite

### Test Example 2

Twenty parts by weight of the detergent builder granules obtained in Example 3, Example 16, or Example 20 were mixed with 80 parts by weight of a detergent shown in Table 2. The low-temperature dispersibility of a case where only a detergent is contained, and three cases where the detergent builder granules were mixed with the detergent, is shown in Table 3.

TABLE 2

| | Detergent | Detergent | Detergent | Detergent |
|---|---|---|---|---|
| | 1 | 2 | 3 | 4 |
| LAS-Na | 3 | 10 | 18 | 0 |
| alpha-SFE | 10 | 0 | 0 | 13 |
| Nonion 1 | 5 | 10 | 3 | 5 |
| Fatty Acid Sodium | 10 | 5 | 9 | 10 |
| Sodium Carbonate | 20 | 20 | 30 | 20 |
| Potassium Carbonate | 10 | 0 | 0 | 10 |
| Sodium Sulfate | 6 | 18 | 20 | 0 |
| Zeolite | 30 | 30 | 10 | 30 |
| AA/MA Polymer | 1 | 3 | 5 | 1 |
| PEG | 0 | 0 | 0 | 10 |
| Fluorescer | 0.5 | 0.5 | 0.5 | 0.5 |
| Perfume | 0.5 | 0.5 | 0.5 | 0.5 |
| Water | 4 | 3 | 4 | 0 |
| Total | 100 | 100 | 100 | 100 |
| Bulk Density (g/L) | 800 | 850 | 780 | 800 |

LAS-Na: Sodium linear alkylbenzenesulfonate of which alkyl moiety has 12 to 14 carbon atoms;
alpha-SFE: Ethyl ester of α-Sulfofatty acid(derived from palm oil) sodium
Nonionic 1: A product obtained by adding EO to a primary alcohol having 10 to 14 carbon atoms in an average of 8 mol
Fatty acid sodium: Fatty acid sodium of which alkyl moiety has 14 to 18 carbon atoms
Zeolite: Zeobuilder (4A-type, average particle size: 3.5 μm, manufactured by Zeobuilder)
AA/MA Polymer: Acrylic acid-maleic acid copolymer (sodium salt (70% by mol neutralization), a molar ratio being acrylic acid/maleic acid- 3/7 (molar ratio), average molecular weight 70000)
PEG: Polyethylene glycol (weight-average molecular weight 8500)
Fluorescer: Blend of Tinopal CBS-X (manufactured by Ciba Geigy AG) and WHITEX SA (manufactured by Sumitomo Chemical Co., Ltd. in a ratio of 1/1(weight ratio)

TABLE 3

| | Temp.-Time | Detergent 1 | Detergent 2 | Detergent 3 | Detergent 4 |
|---|---|---|---|---|---|
| Detergent Only | 5° C.-3 min. | II | II | III | I |
| | 5° C.-5 min. | II | III | IV | II |
| Detergent + Detergent Builder | 5° C.-3 min. | I | I | I | I |
| Granules of Example 3 | 5° C.-5 min. | I | I | II | I |
| Detergent + Detergent Builder | 5° C.-3 min. | I | I | I | I |
| Granules of Example 16 | 5° C.-5 min. | I | I | I | I |
| Detergent + Detergent Builder | 5° C.-3 min. | I | I | I | I |
| Granules of Example 20 | 5° C.-5 min. | I | I | I | I |

As shown in Table 3, all the detergent compositions containing the detergent and the detergent builder granules showed excellent low-temperature dispersibility under both of the conditions of 5° C. for 3 minutes and 5° C. for 5 minutes, as compared to a case of the detergent only.

### INDUSTRIAL APPLICABILITY

According to the present invention, the detergent builder granules for laundry detergents having excellent dispersibility in cold water and a detergent composition containing the detergent builder granules can be obtained.

### BRIEF DESCRIPTION OF THE DRAWINGS

FIG. 1 shows an X-ray diffraction spectrum of the detergent builder granules obtained by Example 3.

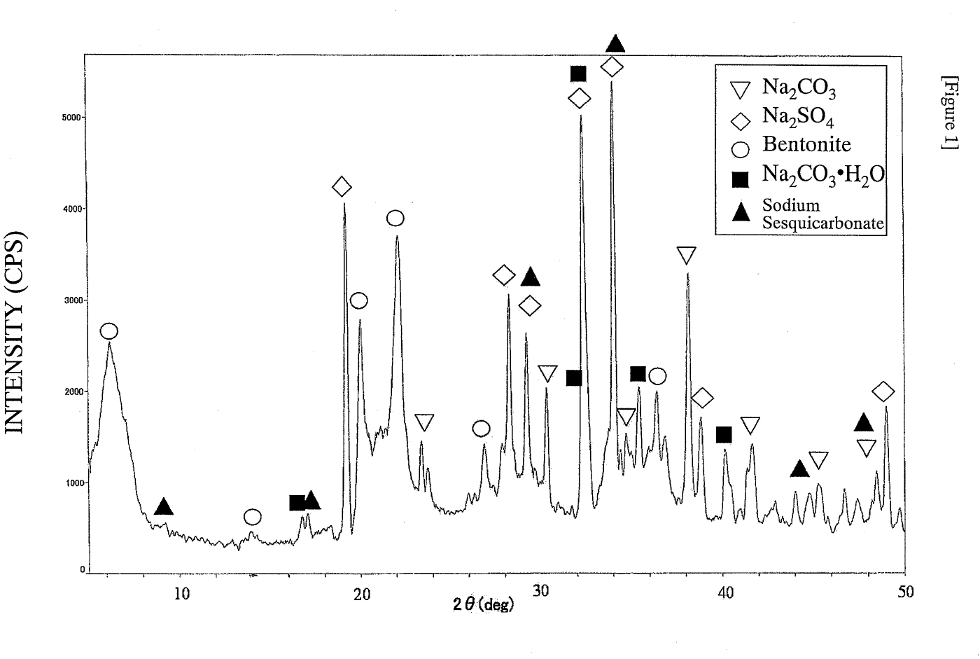

FIG. 2 shows the results of elemental analysis of a cross section according to SEM-EDS analysis of the detergent builder granules obtained by Example 3. The left panel shows a cross section before the elemental analysis by EDS, and the right panel shows a cross section after the elemental analysis.

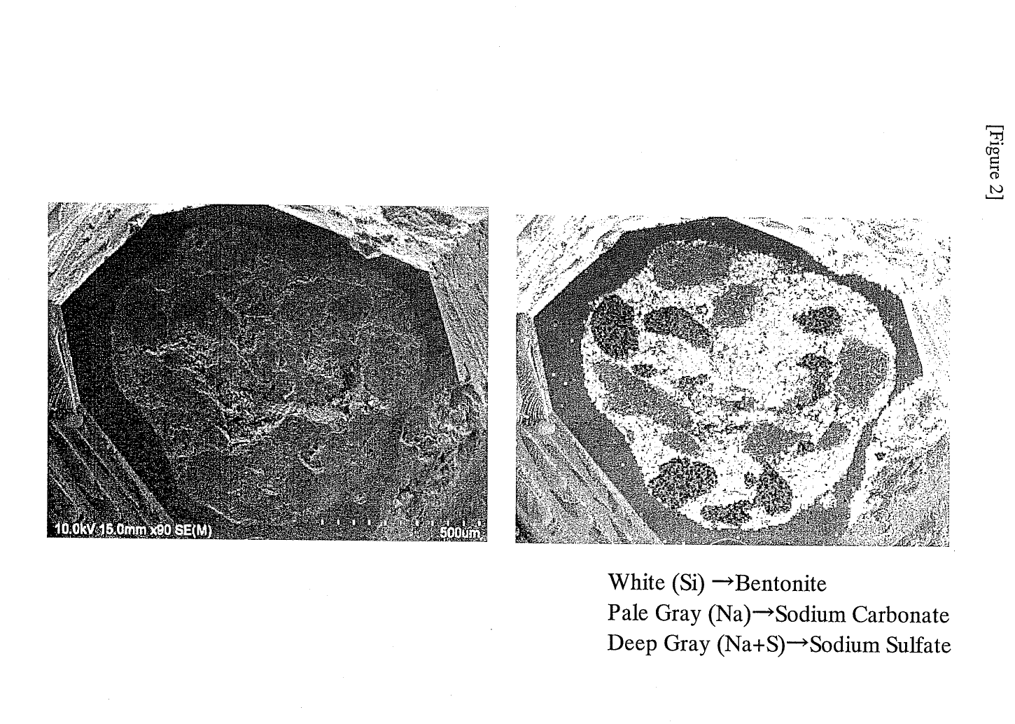

1. Detergent builder granules comprising:
(component A) a water-soluble inorganic salt comprising an inorganic salt having and/or being capable of forming a hydrate crystal and
(component B) a clay mineral,
wherein the component B is contained in an amount of 60% by weight or less, the component A and the component B are in a weight ratio, i.e. A/B, calculated as an anhydrate, of from 5/95 to 80/20, and a percentage of water loss upon heating to a temperature of 200° C. is from 3 to 30% by weight.

2. The detergent builder granules according to claim 1, wherein the component A is one or more salts selected from the group consisting of carbonates, sulfates, and chlorides.

3. The detergent builder granules according to claim 1 or 2, obtainable by the method comprising:
step 1: mixing the component A and the component B;
step 2: adding water (component C) to a mixture obtained in the step 1 to granulate a mixture obtained; and
step 3: adding fine particles to a granular surface of granules obtained in the step 2 to surface-modify the granules.

4. The detergent builder granules according to claim 1 or 2, obtainable by the method comprising:
step a: mixing the component A and a part of the component B;
step b: adding water (component C) to a mixture obtained in the step a to granulate a mixture obtained; and
step c: mixing a part or all of a remainder of the component B with granules obtained in the step b, and adding the component C to granulate a mixture obtained in the step b.

5. The detergent builder granules according to claim 4, further comprising:
step d: mixing the component B with granules obtained in the step c, and adding the component C to granulate a mixture obtained.

6. A detergent composition comprising the detergent builder granules as defined in claim 1.
